(19) United States
(12) Patent Application Publication
(10) Pub. No.: US 2007/0223157 A1
(43) Pub. Date: Sep. 27, 2007

(54) ESD protection circuit and method thereof

(75) Inventors: Tzung-Ming Chen, Taiwan (TW); Ka-Un Chan, Taiwan (TW); Ying-Hsi Lin, Taiwan (TW)

Correspondence Address: BIRCH STEWART KOLASCH & BIRCH, PO BOX 747, FALLS CHURCH, VA, 22040-0747, US

(73) Assignee: Realtek Semiconductor Corp.

(21) Appl. No.: 11/723,911

(22) Filed: Mar. 22, 2007

(30) Foreign Application Priority Data
Mar. 24, 2006 (TW) 095110192

(51) Int. Cl. H02H 9/00

(52) U.S. Cl. 361/56

(57) ABSTRACT

An electrostatic discharge (ESD) protection circuit and method thereof is provided. The circuit comprises a clamping circuit, an inductor, a diode and a diode string. In order for a voltage swing of an output voltage to get rid of the influence of the ESD protection circuit, the number of diodes in the diode string must be greater than or equal to the voltage swing divided by the turn-on voltage of the diodes.

### BACKGROUND OF THE INVENTION

1. Field of the invention

The invention relates to electrostatic discharge (ESD) protection, and more particularly, to an ESD protection circuit and method thereof for power amplifiers.

2. Description of the Related Art

FIG. 1 is a schematic circuit diagram of a conventional ESD protection circuit. Referring now to FIG. 1, an ESD protection circuit 100, installed at the output terminal of the output circuit 110, comprises a clamping circuit 120 and two series-connected diodes Dₚ₁, Dₙ₁; meanwhile, both the output circuit 110 and the clamping circuit 120 are coupled between a first operating voltage V_{dd} and a second operating voltage Vₛₛ. While the diode Dₚ₁ has its anode (p-type side) connected to an output pad Pₒ and its cathode (n-type side) connected to the first operating voltage V_{dd}, the diode Dₙ₁ has its cathode connected to the output pad Pₒ and its anode connected to the second operating voltage Vₛₛ. Thus, if an ESD event occurs at the output pad Pₒ of the output circuit 110, an ESD damage to the output circuit 110 is avoided due to the turn-on of either the diode Dₚ₁ or the diode Dₙ₁ .

On the other hand, the clamping circuit 120 comprises an electrostatic discharge unit 130 and an ESD detecting circuit 140. The electrostatic discharge unit 130 includes a NMOS transistor T_{N}, whereas the ESD detecting circuit 140 includes a resistor R₁, a capacitor C₁ and an inverter D₁. While an electrostatic current flows to the output circuit 110 through the output pad P_{O} and voltage sources (V_{dd}, Vₛₛ), the ESD detecting circuit 140 triggers the electrostatic discharge unit 130 to bypass the electrostatic current without damaging the output circuit 110.

As shown in FIG. 2A, an output voltage Vₒᵤₜ measured at the output pad Pₒ has a DC voltage component of about V_{dd}/2 and a voltage swing S of V_{dd}/2, causing the output voltage Vₒᵤₜ to swing between 0 and V_{dd}. However, on condition that the voltage swing S is greater than 0.7V, the diode Dₚ₁ turns on and accordingly the maximum output voltage Vₒᵤₜ₍ₘₐₓ₎ measured at the output pad Pₒ is no more than (V_{dd}+0.7V) as shown in FIG. 2B. In general, the output voltage Vₒᵤₜ of a power amplifier has a larger voltage swing S of V_{dd}/2, e.g., up to 3V. Consequently, while the output voltage Vₒᵤₜ that the power amplifier provides to the output pad Pₒ is greater than (V_{dd}+0.7V), a part of the output voltage Vₒᵤₜ that is greater than (V_{dd}+0.7V) will be clipped. Therefore, if the output circuit 110, either a power amplifier or a high-voltage output circuit, simply employs the ESD protection circuit 100 for circuit protection, the performance of either the power amplifier or the high-voltage output circuit is limited or affected by the ESD protection circuit 100.

### SUMMARY OF THE INVENTION

In view of the above-mentioned problems, an object of the invention is to provide a voltage swing outputted from a high-voltage output circuit, without being limited by an ESD protection circuit.

The invention discloses an ESD protection circuit applied to an output circuit, comprising: a clamping circuit located between a first operating voltage and a second operating voltage; an inductor coupled between an output terminal of the output circuit and the first operating voltage; and, a diode string coupled between the output terminal and the first operating voltage.

The invention further discloses an ESD protection method applied to a power amplifier circuit, comprising: providing a clamping circuit located between a first operating voltage and a second operating voltage; providing an inductor coupled between an output terminal of the output circuit and the first operating voltage; providing a diode string coupled between the output terminal and the first operating voltage; and, determining the number of diodes in the diode string according to a voltage swing of an output signal of the output terminal.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic circuit diagram of a conventional ESD protection circuit.

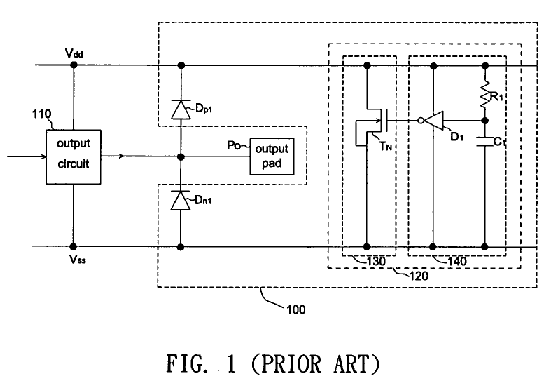

FIG. 2A shows an output voltage waveform measured at an output pad shown in FIG. 1 while a voltage swing S is less than or equal to 0.7V.

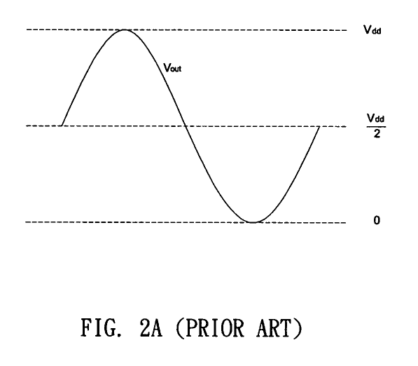

FIG. 2B shows an output voltage waveform measured at the output pad shown in FIG. 1 while a voltage swing S is greater than 0.7V.

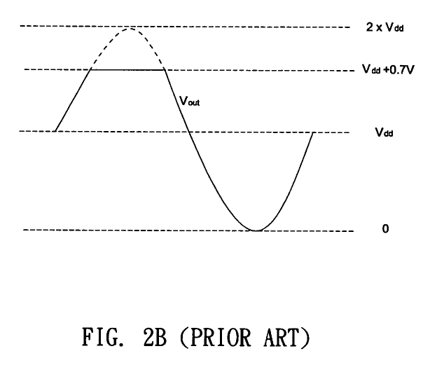

FIG. 3A is a schematic circuit diagram showing a first embodiment of the invention.

FIG. 3B shows an output voltage waveform measured at the output pad shown in FIG. 3A.

FIG. 4A is a schematic circuit diagram showing a second embodiment of the invention.

FIG. 4B shows an output voltage waveform measured at the output pad shown in FIG. 4A.

FIG. 5 is a flow chart illustrating an ESD protection method according to the invention.

### DETAILED DESCRIPTION OF THE INVENTION

The ESD protection circuit and method thereof of the invention will be described with reference to the accompanying drawings.

In order for a voltage swing S of an output voltage Vₒᵤₜ generated by a high-voltage output circuit to get rid of the influence of an ESD protection circuit, the invention adds a diode string with the number M of diodes in the diode string greater than or equal to S divided by the turn-on voltage of the diodes. Conventionally, the turn-on voltage of general diodes is approximately 0.7V. As semiconductor-manufacturing technology advances, the turn-on voltage may vary and be not restricted to 0.7V.

Suppose that the voltage swing S of the output voltage Vₒᵤₜ generated by the output circuit 110 is equal to 3V. In order for the voltage swing S of the output voltage Vₒᵤₜ to get rid of the influence of an ESD protection circuit, the number M of diodes in the diode string needs to be greater than (3/0.7=4.3). In other words, the number M must be greater than or equal to 5, i.e., requiring five or more diodes. Hereinafter, for an explanation, all embodiments of the invention are described with S=3V, M=5.

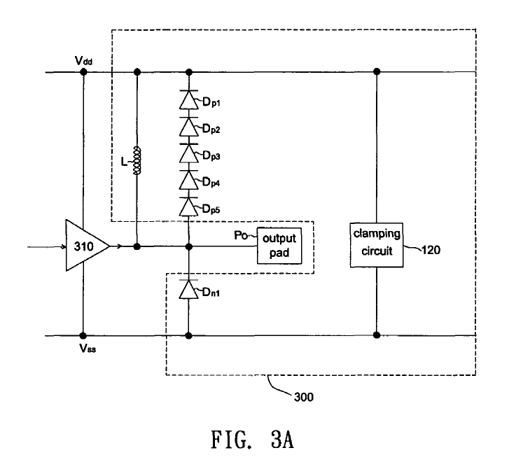

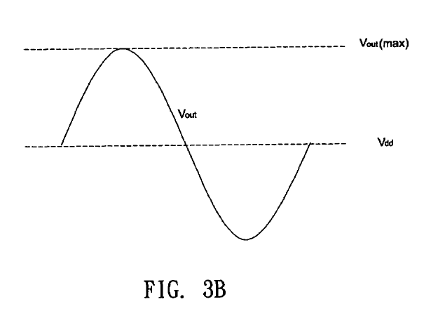

FIG. 3A is a schematic circuit diagram showing a first embodiment of the invention. According to the first embodiment of the invention, an ESD protection circuit 300, installed at the output terminal of a power amplifier 310, comprises a clamping circuit 120, an inductor L, a diode Dₙ₁ and a diode string Dₚ₁˜Dₚ₅. The clamping circuit 120 is coupled between a first operating voltage V_{dd} and a second operating voltage Vₛₛ. The implementation of the clamping circuit 120 is well known to those skilled in the art and thus will not be described herein. The diode Dₙ₁has its cathode coupled to the output pad Pₒ and its anode coupled to the second operating voltage Vₛₛ, whereas the diode string Dₚ₁˜Dₚ₅ has its anode coupled to the output pad Pₒ and its cathode coupled to the first operating voltage V_{dd}.

In the first embodiment, the last stage of the power amplifier 310 is either a NMOS transistor (not shown) with its drain connected to the output pad Pₒ or a NPN bipolar transistor (not shown) with its collector connected to the output pad Pₒ. In addition, the inductor L is coupled between the first operating voltage V_{dd} and the output pad Pₒ so as to increase the circuit bandwidth and pull the output DC voltage level up to V_{dd}. In view that the number M of diodes in the diode string is equal to five, the voltage swing S (=3V) of the output voltage Vₒᵤₜ is no longer limited by the ESD protection circuit 300, therefore rendering a perfect symmetrical waveform as shown in FIG. 3B. On condition that the output voltage Vₒᵤₜ greater than (V_{dd}+3.5V) is caused by voltage spikes having been generated at the output terminal of the power amplifier 310, the output voltage Vₒᵤₜ will be clipped at (V_{dd}+3.5V) so that the maximum output voltage Vₒᵤₜ at the output pad Pₒ is no more than (V_{dd}+3.5V).

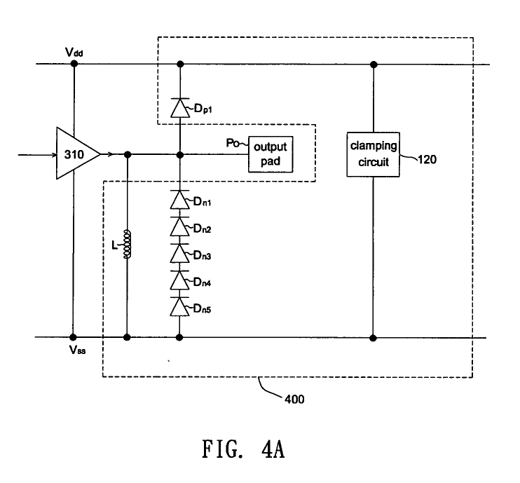

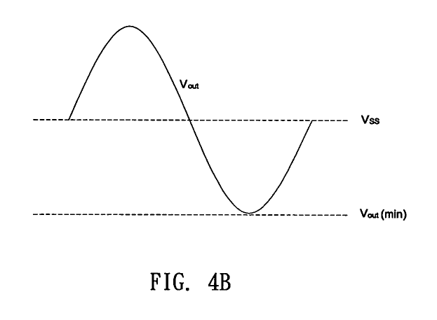

FIG. 4A is a schematic circuit diagram showing a second embodiment of the invention. According to the second embodiment of the invention, an ESD protection circuit 400 comprises a clamping circuit 120, an inductor L, a diode Dₚ₁ and a diode string Dₙ₁˜Dₙ₅. Since the operations of the second embodiment are similar to those of the first embodiment, repeated description is omitted herein. The last stage of the power amplifier 310 is either a PMOS transistor (not shown) with its drain connected to the output pad Pₒ or a PNP bipolar transistor (not shown) with its collector connected to the output pad Pₒ. In addition, the inductor L is coupled between the second operating voltage Vₛₛ and the output pad Pₒ so as to increase the circuit bandwidth and pull the output DC voltage level low to Vₛₛ.

In the second embodiment, the voltage swing S (=3V) of the output voltage Vₒᵤₜ is no longer limited by the ESD protection circuit 400, therefore rendering a perfect symmetrical waveform as shown in FIG. 4B.

To prevent from affecting the discharge speed due to an incremented number of diodes in the diode string, each diode area in the diode string has to become larger as the number M of diodes increases. In implementation, diodes are generally manufactured by using transistor-manufacturing techniques, so the diode area can be increased by means of broadening the channel width. For example, suppose that the channel width of a diode is 2μ if the number M of diodes is equal to one. Likewise, the channel width for each diode in the diode string needs to be 4μ if the number M of diodes is equal to two, whereas the channel width for each diode in the diode string needs to be 10μ if the number M of diodes is equal to five.

Besides, although the aforementioned two embodiments describe a case of a series-connected diode string, the diode string is not limited to a series configuration but includes other configurations, as the diode string may be modified and practiced in different but equivalent manners apparent to those skilled in the art having the benefit of the teachings herein. Further, although the ESD protection circuit is installed at the output terminal of the power amplifier in the aforementioned two embodiments, the invention is applicable to either all high-power output circuits or all high-voltage output circuits in practical applications

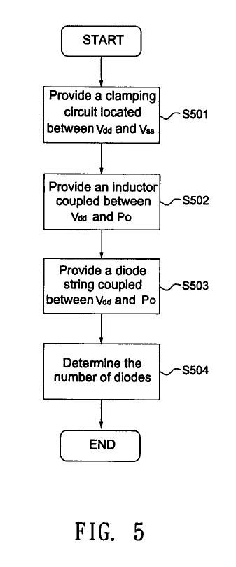

FIG. 5 is a flow chart illustrating an ESD protection method according to the invention. The ESD protection method in accordance with FIGS. 3A, 4A and 5 is detailed as follows.

Step S501: Providing a clamping circuit located between the first operating voltage V_{dd} and the second operating voltage Vₛₛ.

Step S502: Providing an inductor L located between the first operating voltage V_{dd} and the output pad Pₒ.

Step S503: Providing a diode string located between the first operating voltage V_{dd} and the output pad Pₒ.

Step S504: Determining the number of diodes in the diode string according to the voltage swing S of the output signal generated at the output pad Pₒ.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A ESD protection circuit for protecting an output circuit, comprising:
a clamping circuit coupled between a first operating voltage and a second operating voltage;
an inductor coupled between an output terminal of the output circuit and the first operating voltage; and
a diode string, which comprises at least one of first diodes, coupled between the output terminal and the first operating voltage.

2. The circuit of claim 1, wherein the output circuit comprises a plurality of stages, wherein the last stage of the output circuit is a MOS transistor and a drain of the MOS transistor is the output terminal.

3. The circuit of claim 1, wherein the output circuit comprises a plurality of stages, wherein the last stage of the output circuit is a bipolar transistor and a collector of the bipolar transistor is the output terminal.

4. The circuit of claim 1, wherein the area of each first diode in the diode string increases as the number of the first diodes increases.

5. The circuit of claim 1, further comprising:
a second diode coupled between the output terminal and the second operating voltage.

6. The circuit of claim 1, wherein the output circuit is a power amplifier.

7. The circuit of claim 1, wherein a number of the first diodes in the diode string is greater than or equal to a voltage swing of the output terminal divided by a turn-on voltage of the first diode.

8. The circuit of claim 1, wherein a number of the first diodes in the diode string corresponds to a voltage swing of an output signal of the output terminal.

9. A ESD protection method applied to an output circuit, comprising:
providing a clamping circuit coupled between a first operating voltage and a second operating voltage;
providing an inductor coupled between an output terminal of the output circuit and the first operating voltage; and
providing a diode string coupled between the output terminal and the first operating voltage, wherein the diode string comprises at least one of first diodes.

10. The method of claim 9, wherein a number of the first diodes in the diode string corresponds to a voltage swing of an output signal of the output terminal.

11. The method of claim 9, further comprising:
providing a second diode coupled between the output terminal and the second operating voltage.

12. The method of claim 11, wherein the output circuit is a power amplifier.

13. The method of claim 9, wherein a number of the first diodes in the diode string is substantially greater than or equal to a voltage swing of the output signal of the output terminal divided by a turn-on voltage of the first diode.

14. The method of claim 13, further comprising:
providing a second diode coupled between the output terminal and the second operating voltage.

15. The method of claim 9, wherein the output circuit is a power amplifier.
